(19) United States
(12) Patent Application Publication
(10) Pub. No.: US 2026/0335180 A1
(43) Pub. Date: Oct. 29, 2026

(54) WEARABLE THERAPY DEVICES WITH ELECTROMAGNETIC FREQUENCY TRANSDUCERS

(71) Applicant: Sheryl Edgerly, Salt Lake City, UT (US)

(72) Inventor: Sheryl Edgerly, Salt Lake City, UT (US)

(21) Appl. No.: 19/706,343

(22) Filed: Jun. 12, 2026

(51) Int. Cl. A61H 23/02; H04R 1/02; H04R 9/06

(52) U.S. Cl. CPC A61H 23/0236; H04R 1/028; H04R 9/06; A61H 2201/163; A61H 2201/165; H04R 2400/03

(57) ABSTRACT

Wearable therapy devices including a wearable pouch and an electromagnetic frequency transducer. The wearable pouch defines an interior space. The electromagnetic frequency transducer is disposed in the interior space and electrically coupled to an audio device. The electromagnetic frequency transducer is configured to convert sound signals into inaudible and tactilely imperceptible vibrations.

### BACKGROUND

The present disclosure relates generally to therapy devices. In particular, wearable therapy devices with electromagnetic frequency transducers are described.

Therapy products are commonly used for medical and non-medical purposes. Some therapy devices address pain or muscle soreness while other devices are used for calming and relaxation purposes. Therapy devices can be used to foster physiological alignment and wellness as well as to promote hormonal, electrolyte, and chemical balance.

Known therapy devices are not entirely satisfactory for the range of applications in which they are employed. For example, existing therapy devices are not always convenient to use. Many therapy devices must be held near a target region of the body with their hands, which is cumbersome and limiting.

Certain therapy devices are configured to be worn or secured to the body in some fashion rather than needing to be handheld. However, conventional therapy devices that may be worn or secured to the body often are specially configured for a certain region of the body, such as the knee or shoulder, and are not adapted to be readily worn in different locations on the body. Further, conventional therapy devices that may be worn or secured to the body generally include complicated securement means that increase their cost and/or make them impractical to use in a variety of ways.

Conventional therapy devices typically use heat, cold, pressure, tactile vibrations, or audible sound, such as white noise, for therapeutic purposes. However, existing therapy devices fail to utilize inaudible and imperceptible sound waves for therapeutic purposes as extensively as would be beneficial and, thus, do not provide the unique therapy benefits of inaudible and imperceptible sound waves. It would be desirable to have a novel therapy device that more accessibly utilized inaudible and imperceptible sound waves for therapeutic purposes to targeted areas of the body.

Another limitation of conventional therapy devices is that they are not sufficiently universal with commonly used electronic devices. Conventional therapy devices are often standalone devices, which can quickly become outdated and/or are not readily adaptable to different therapy regimens. Undesirably, conventional therapy devices that utilize inaudible sound waves depend on a specially configured electronic device that runs specific, embedded programs to operate. It would be beneficial to have a novel therapy device that could readily connect to common personal electronic devices and that could be easily operated in a variety of different ways via the personal electronic devices.

Thus, there exists a need for wearable therapy devices that improve upon and advance the design of known wearable therapy devices. Examples of new and useful wearable therapy devices relevant to the needs existing in the field are discussed below.

### SUMMARY

The present disclosure is directed to wearable therapy devices including a wearable pouch and an electromagnetic frequency transducer.

The wearable pouch defines an interior space. The electromagnetic frequency transducer is disposed in the interior space and electrically coupled to an audio device. The electromagnetic frequency transducer is configured to convert sound signals into inaudible and tactilely imperceptible vibrations. In some examples, the electromagnetic frequency transducer includes multiple transducer coils.

### BRIEF DESCRIPTION OF THE DRAWINGS

FIG. 1 is a view of a first example of a wearable therapy device supported on a user's waist and coupled to an audio device in the form of a smart phone with an audio cable.

FIG. 2 is a view of the wearable therapy device shown in FIG. 1 with a wearable pouch depicted transparently to reveal components disposed inside the wearable pouch, including an electromagnetic frequency transducer with two transducer coils.

FIG. 3 is a view of the wearable therapy device shown in FIG. 1 with an audio device in the form of a smartphone disconnected from a signal cable used to communicate audio signals to the electromagnetic frequency transducer.

FIG. 4 is a view of the wearable therapy device shown in FIG. 1 with three audio devices suitable for connecting to the signal cable and for sending audio signals to the electromagnetic frequency transducer.

FIG. 5 is a perspective view of the electromagnetic frequency transducer of the wearable therapy device shown in FIG. 1.

FIG. 6 is a top view of the electromagnetic frequency transducer of the wearable therapy device shown in FIG. 1 along with the audio device disposed outside an interior space of a wearable pouch with covers of the transducers removed to reveal transducer coils of the electromagnetic frequency transducer.

FIG. 7 is a perspective view of one of the transducer coils included in the electromagnetic frequency transducer of the wearable therapy device shown in FIG. 1 electrically connected to an electrical connector.

FIG. 8 is a perspective view of the electrical connector shown in FIG. 7.

FIG. 9 is a perspective view of a solder-seal connector suitable for forming a soldered connection between a transducer coil and a signal cable.

### DETAILED DESCRIPTION

The disclosed wearable therapy devices will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various wearable therapy devices are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.
“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.
“Comprising,” “including,” and “having” (and conjugations thereof) are used interchangeably to mean including but not necessarily limited to, and are open-ended terms not intended to exclude additional elements or method steps not expressly recited.
Terms such as “first”, “second”, and “third” are used to distinguish or identify various members of a group, or the like, and are not intended to denote a serial, chronological, or numerical limitation.
“Coupled” means connected, either permanently or releasably, whether directly or indirectly through intervening components.
“Communicatively coupled” means that an electronic device exchanges information with another electronic device, either wirelessly or with a wire-based connector, whether directly or indirectly through a communication network.
“Controllably coupled” means that an electronic device controls operation of another electronic device.

### Contextual Details

Ancillary features relevant to the wearable therapy devices described herein will first be described to provide context and to aid discussing the wearable therapy devices.

### Audio Devices

The wearable therapy devices described herein are used with audio devices. In particular, the wearable therapy devices receive audio signals from audio devices and convert the audio signals into inaudible and tactilely imperceptible vibrations.

The audio devices used with the novel wearable therapy devices may be any currently known or later developed type of audio device. For example, the audio device may be a media player, a smartphone, a computer, a tablet device, a wearable smart device, such as a smart watch or smart glasses, a frequency generator, an audio receiver, an audio processor, or a wide variety of other conventional audio devices.

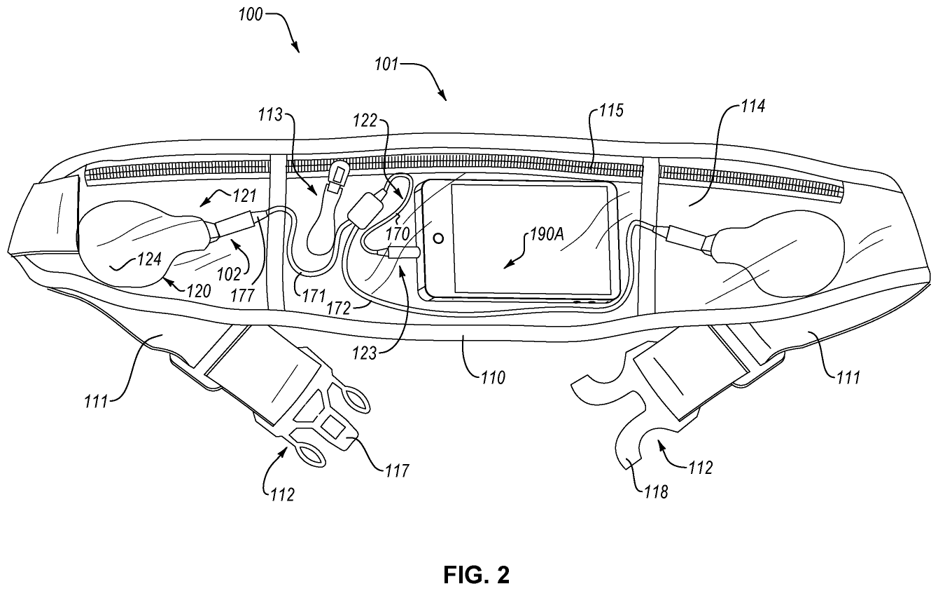

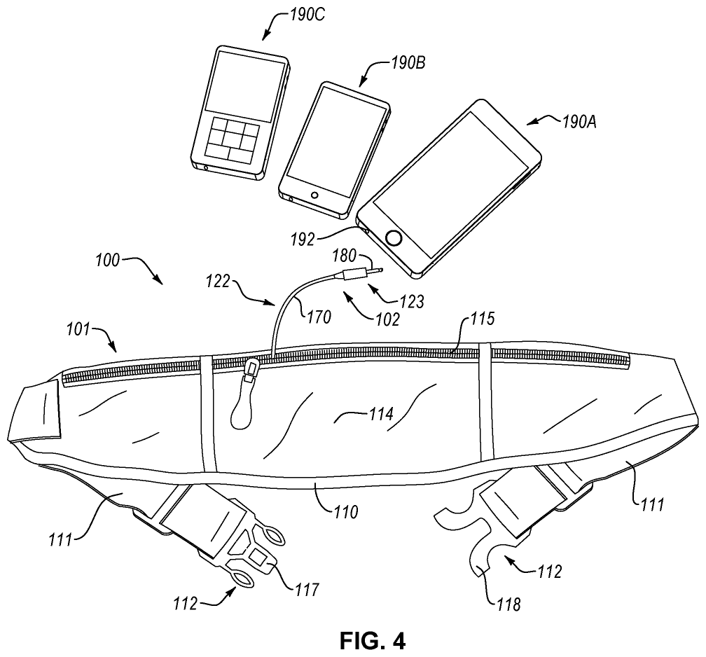

One example of a suitable audio device, audio device 190A, is shown in FIGS. 2-4 and 6. Two alternative audio devices 190B and 190C are also depicted in FIG. 4. Audio devices 190A and 190B are smartphones. Audio device 190C is a media player. Each audio device 190A-190C is configured to electrically couple to wearable therapy device 100 with a signal cable 122 and an audio connector 123. Audio connector 123 is complementarily configured with an audio port 192 of audio devices 190A, 190B, and 190C.

The audio device may deliver audio signals from signals created from data stored in memory, data read from media, data received via broadcast transmissions, or data streamed over the internet. In some examples, the data used to generate audio signals is obtained from a media file, such as an mp3 file. In some instances, the data used to generate audio signals is streamed from media platforms like YouTube® or Spotify®. In certain examples, a mobile application like Audio Function Generator™ is used by the audio device to generate audio signals from a user selected vibration frequency selected from a Hertz scale.

With reference to the figures, wearable therapy devices with electromagnetic frequency transducers will now be described. The wearable therapy devices discussed herein function to direct inaudible sound waves to target areas of a user's body when worn near the target areas.

The reader will appreciate from the figures and description below that the presently disclosed wearable therapy devices address many of the shortcomings of conventional therapy devices. For example, the novel wearable therapy devices are convenient to use since they can be worn near target therapy areas rather than needing to be handheld. The ability to wear the novel therapy devices frees one's hands for endeavors other than holding the device.

The novel wearable therapy devices may be flexibly positioned on different regions of the body because they are not specially configured for only a particular region of the body. The novel wearable therapy devices are advantageously adapted to be readily worn in different locations on the body. Further, the novel wearable therapy devices include a simple strap and clip structure to secure to different regions of a user's body rather than complicated securement means. The simplicity of the securement means used by the novel wearable therapy devices makes them less expensive and more practical to use in a variety of ways.

Importantly, the novel wearable therapy devices utilize inaudible sound waves for therapeutic purposes and, thus, provide the unique therapy benefits of inaudible sound waves. Desirably, the novel wearable therapy devices enable targeted areas of the body to receive inaudible sound wave therapy, which is a therapy mechanism insufficiently used in conventional therapy devices.

Another benefit of the novel wearable therapy devices is that they can be universally used with common electronic devices. By being compatible with personal electronic devices, the novel wearable therapy devices can deliver evolving therapy regimens over time rather than being limited to therapy regimens existing when the device was released and/or requiring cumbersome update procedures. Beneficially the novel wearable therapy devices can readily connect to common personal electronic devices and can be easily operated in a variety of different ways via the personal electronic devices.

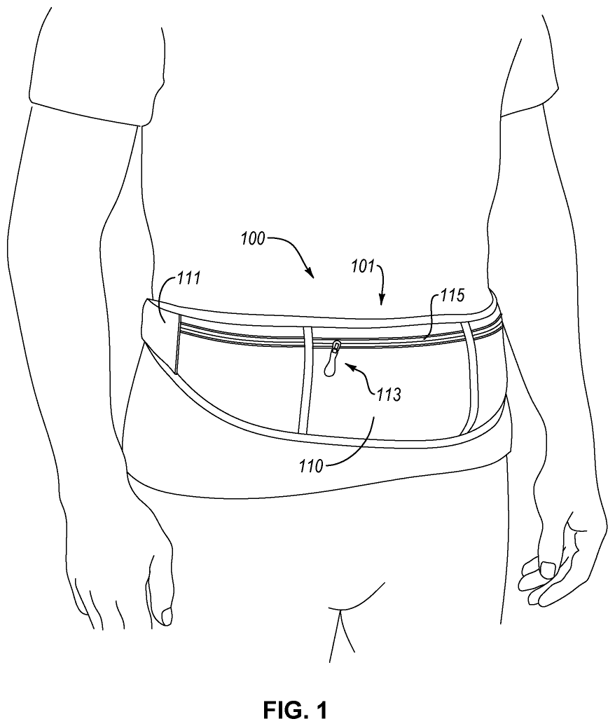

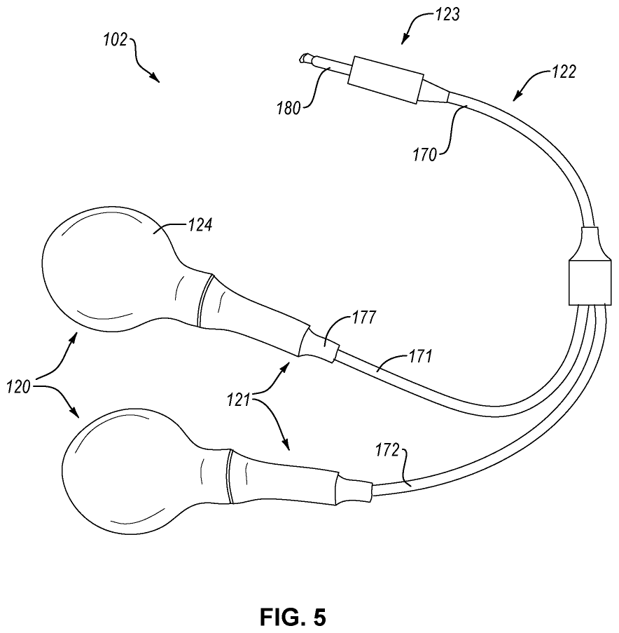

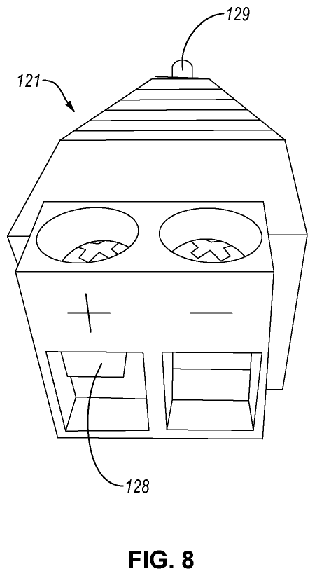

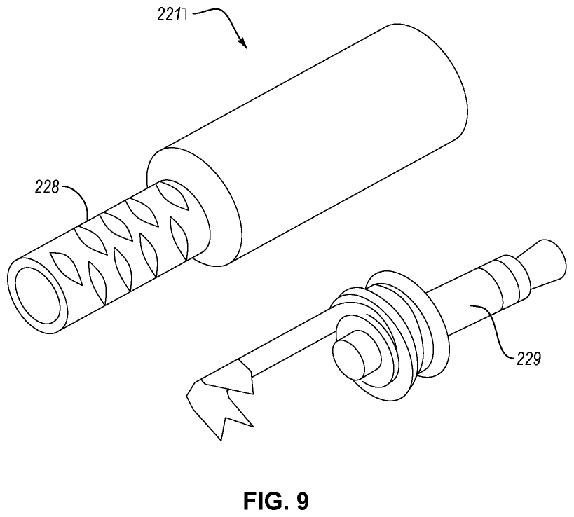

FIGS. 1-8 depict a first embodiment of a wearable therapy device, wearable therapy device 100. FIG. 9 depicts an alternative electrical connector suitable for soldering components of the wearable therapy devices described herein. Wearable therapy device 100 is described in detail below with reference to FIGS. 1-9.

### Embodiment One

As shown in FIGS. 1-8, wearable therapy device 100 includes a wearable pouch 101 and an electromagnetic frequency transducer 102. The components of wearable therapy device 100 are described in the sections below.

In some examples, the wearable therapy device does not include one or more features included in wearable therapy device 100. For example, some wearable therapy device examples do not include a wearable pouch. In other examples, the wearable therapy device includes additional or alternative features beyond those included in wearable therapy device 100.

The size, shape, and configuration of the wearable therapy device may differ from that shown in FIGS. 1-8 while maintaining the function and utility of wearable therapy device 100. Some wearable therapy devices are configured to be worn on specific parts of the body, such as an arm, leg, or neck and may be of a size, shape, and configuration suitable for the intended body part.

### Wearable Pouch

Wearable pouch 101 functions to support and contain transducer 102. As shown in FIGS. 2-4, audio device 190A may optionally be contained within wearable pouch 101 as well or disposed outside wearable pouch 101.

Wearable pouch 101 also serves to position transducer 102 proximal to a selected target area of a user's body. In the example shown in FIG. 1, wearable pouch 101 positions transducer 102 proximal to lateral sides of the user's waist due to wearable pouch being worn on the user's waist. Wearable pouch 101 could be worn on other parts of the user's body, such as across the user's chest or across the user's back.

As shown in FIGS. 1-4, wearable pouch 101 includes a pouch 110, a strap 111, a clip 112, and a closure mechanism 113. In some examples, the wearable pouch includes internal securement means, such as internal straps, rivets, or sleeves, to secure the transducer in a desired position. In certain examples, the wearable pouch includes fewer or alternative components than wearable pouch 101. The components of wearable pouch 101 are described in the sections below.

### Pouch

In the present example, pouch 110 includes pliable walls. However, the walls of the pouch may be rigid or semi-rigid in other examples.

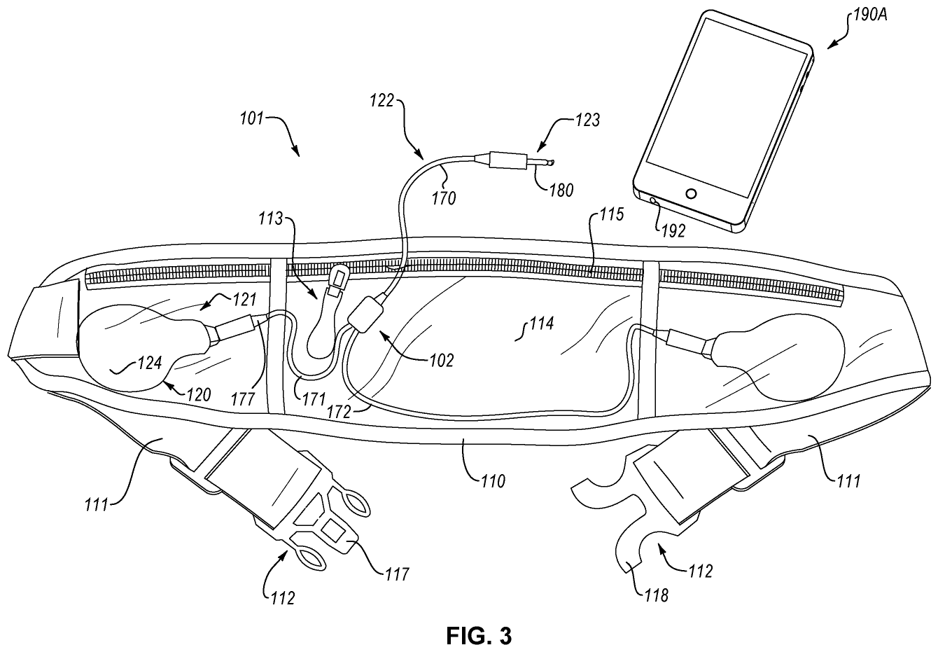

With reference to FIGS. 2 and 3, the reader can see that pouch 110 defines an interior space 114. Interior space 114 is sized to accommodate transducer 102, audio device 190A, and other potential items. Transducer 102 is disposed in interior space 114. Audio device 190A may also be selectively disposed in interior space 114.

FIGS. 1-4 demonstrate that pouch 110 defines a pouch opening 115. Pouch opening 115 provides access to interior space 114. Closure mechanism 113 is sewn to pouch 110 at pouch opening 115.

### Closure Mechanism

Closure mechanism 113 is configured to selectively cover pouch opening 115 to restrict transducer 102, audio device 190A, and other items from exiting interior space 114 when not intended. Closure mechanism 113 may be adjusted to uncover pouch opening 115 enabling transducer 102 and/or audio device 190A to be selectively placed within or removed from interior space 114.

In the present example, closure mechanism 113 is a zipper. However, the closure mechanism may be any currently known or later developed type of closure mechanism suitable for selectively covering the pouch opening. Suitable closure mechanisms include flaps with buttons, snaps, or hook-and-loop fasteners.

### Strap

As shown most clearly in FIGS. 2-4, strap 111 is coupled to pouch 110 on opposite ends of pouch 110. FIG. 1 demonstrates that strap 111 is configured to selectively mount to a user's body. In the present example, strap 111 mounts to the user's waist. However, the strap may be supported from a user's shoulder; secure around a foot, leg, arm, hand, neck, or head; or hang from a user's neck.

The strap may be any currently known or later developed type of strap or securement member. A variety of elongate tension bearing members, such as cords, belts, or bands, are suitable replacements for strap 111 shown in FIGS. 1-4. The strap may be formed from any currently known or later developed material suitable for strap applications, including resilient and non-resilient materials.

### Clip

As depicted in FIGS. 2-4, clip 112 mounted to longitudinal ends of strap 111. Clip 112 includes a male end 117 and a female end 118. Male end 117 is coupled to a first longitudinal end of strap 111 and female end 118 is coupled to a second longitudinal end of strap 111.

Female end 118 of clip 112 is configured to receive male end 117 of clip 112 to mate ends 117 and 118 together. Mating ends 117 and 118 together functions to couple together the ends of strap 111 secured to ends 117 and 118 of clip 112. As apparent from FIG. 1, linking the ends of strap 111 together secures strap 111 on the user's body when strap 111 and pouch 110 are wrapped around a portion of the user's body.

### Electromagnetic Frequency Transducer

Electromagnetic frequency transducer 102 functions to convert sound signals into inaudible and tactilely imperceptible vibrations. Electromagnetic frequency transducers may be referred to as inductors, transducers, inductor transducers, electromagnets, and (somewhat inaccurately) solenoids. This document will generally refer to electromagnetic frequency transducers as simply transducers, but the reader should understand that the other terms could alternatively be used.

As apparent from FIGS. 2-4 and 6, transducer 102 is selectively and electrically coupled to audio device 190A. Transducer 102 is configured to convert sound signals from audio device 190A into inaudible and tactilely imperceptible vibrations. In the present example, transducer 102 receives sound signals from audio device 190A via a direct connection to audio device with physical cables and connectors, namely, electrical connectors 121, signal cable 122, and audio connector 123. Additionally or alternatively, the transducer may receive sound signals from a receiver in wireless data communication with an audio device.

As can be seen in FIGS. 2 and 3, transducer 102 is disposed in interior space 114 of wearable pouch 101. In some examples, one or more portions of the transducer are secured within the interior space with internal straps or rivets.

Transducer 102 is proximal to a target body region when wearable pouch 101 is worn in a manner that positions pouch 110 proximal to the target body region. The position of transducer 102 on the user's body causes the target body region to be vibrated by the inaudible and tactilely imperceptible vibrations produced by transducer 102. The inaudible and tactilely imperceptible vibrations produced by transducers102 may provide a therapeutic effect to the target body region.

As shown in FIGS. 2, 3, 5, and 6, transducer 102 includes two transducer coils 120, two electrical connectors 121, a signal cable 122, an audio connector 123, and covers 124. In other example, the transducer includes fewer components than transducer 102, such as a single transducer coil and a single electrical connector, or not including a signal cable, an audio connector and/or covers. The components of transducer 102 are described in the sections below.

### Transducer Coils

Transducer coils 120 are configured to convert sound signals from audio device 190A into inaudible and tactilely imperceptible vibrations. Transducer coils 120 are in electrical communication with audio device 190A via electrical connectors 121, signal cable 122, and audio connector 123.

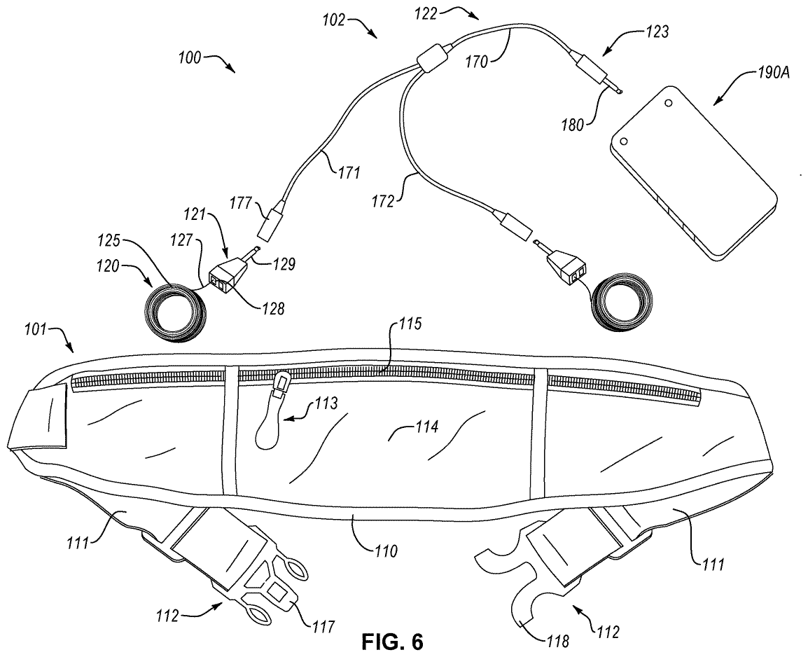

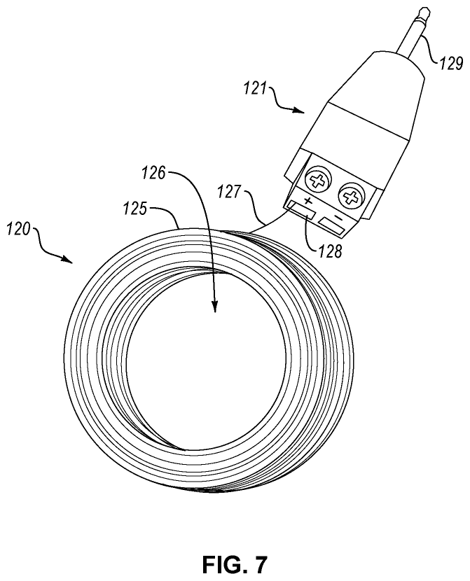

FIGS. 6 and 7 demonstrate that transducer coils 120 are elongate conductors configured in a coil. FIGS. 2, 3, and 5 depict transducer coils 120 optionally covered by covers 124. However, transducer coils 120 operate effectively whether or not they are covered by covers 124.

In the present example, transducer 102 includes two transducer coils 120. However, other examples may include different numbers of transducer coils. For instance, the transducer may include a single transducer coil or three or more transducer coils. The number of transducer coils included is a matter of design choice for a given application. The discussion below describes the structure and features of a single transducer coil with the understanding that the description applies to both transducer coils 120.

With reference to FIGS. 6 and 7, the reader can see that transducer coil 120 defines a cylinder. Transducer coil 120 includes an annular wall 125 defining the cylinder shape. Annular wall 125 is defined by the elongate conductor of transducer coil 120 in a coil configuration.

Annular wall 125 of transducer coil 120 defines a hollow core 126 disposed inside annular wall 125. FIGS. 6 and 7 demonstrate that transducer coil 120 includes a terminal end 127 extending from the annular wall away from hollow core 126.

As depicted in FIGS. 6 and 7, terminal end 127 of transducer coil 120 electrically connects to electrical connector 121. In particular, terminal end 127 electrically connects to a positive terminal 128 of electrical connector 121.

Any currently known or later developed means for establishing an electrical connection between the terminal end of the transducer coil and the electrical connector and/or the signal cable may be used. In the present example, terminal end 127 of transducer coil 120 is compressively coupled to electrical connector via a screw terminal 128 of electrical connector 121. In some examples, the terminal end electrically connects to the electrical connector or signal cable by soldering, wrapping the terminal end around a conductive portion of the electrical connector, or inserting the terminal end into a socket of the electrical connector or signal cable configured to retain the terminal end via a friction fit or retainer.

In certain examples, such as with the solder-seal connector 221 shown in FIG. 9, the terminal end of the transducer coil is soldered to solder-seal connector 221. In particular, in the FIG. 9 application, the terminal end of the transducer coil is soldered to a sealing terminal portion 228 of solder-seal connector 221. A male connector portion 229 of solder-seal connector 221 electrically connects to a signal cable by inserting into a corresponding socket of the signal cable.

### Electrical Connectors

Electrical connectors 121 function to electrically connect transducer coil 120 to signal cable 122. Electrical connector 221 shown in FIG. 9 also functions to electrically connect a transducer coil to a signal cable. In some examples, the transducer coils are electrically connected to the signal cable directly without an electrical connector intermediary.

As shown in FIGS. 6-8, electrical connector 121 is a screw terminal connector. Electrical connector 121 includes two screw terminals 128 and a male terminal 129. One screw terminal 128 correspondes to a positive terminal and the other screw terminal 128 correspondes to a negative terminal.

A single screw terminal 128 of each electrical connector 121 compressively couples to terminal end 127 of transducer coil 120 to form an electrical connection between transducer coil 120 and electrical connector 121. In the present example, each transducer coil 120 exclusively connects with the positive terminal 128 of electrical connectors 121.

Male terminal 129 is disposed along the conduction path of electrical connector 121 on an opposite side of electrical connector 121. Male terminal 129 is complementarily configured with female socket 177 of signal cable 122 to enable male terminal 129 to insert into female socket 177 of signal cable 122. When male terminal 129 inserts into female socket 177, electrical connector 121 is electrically connected to signal cable 122.

FIG. 9 depicts an alternative electrical connector 221. Electrical connector 221 shown in FIG. 9 is a solder-seal type connector. Electrical connector 221 shown in FIG. 9 includes a sealing terminal portion 228 and a male connector portion 229. A terminal end of a transducer coil may be soldered to a sealing terminal portion 228 and automatically sealed with a heat-activated insulating material layer. Male connector portion 229 of solder-seal connector 221 electrically connects to a signal cable by inserting into a corresponding socket of the signal cable.

Screw terminal connectors 121 and solder-seal connector 221 shown in FIGS. 6-9 are just two examples of suitable electrical connectors. The electrical connector may be any currently known or later developed type of electrical connector.

### Signal Cable

Signal cable 122 is configured to conduct audio signals from audio device 190A to transducer coils 120 when electrically coupled to audio device 190A. In the present example, signal cable 122 selectively couples to audio device 190A via audio connector 123 and couples to transducer coils 120 via electrical connectors 121. Other connection methods for connecting the signal cable to the audio device and the transducer coils may be used. For brevity, the discussion below will occasionally refer to signal cables coupling to audio devices and transducer coils, and the reader should understand that audio connectors and electrical connectors may be used to enable the connections.

As shown in FIG. 6, signal cable 122 includes two female sockets 177. Female sockets 177 are tip, ring, screw connectors and complementarily configured with male terminals 129 of electrical connectors 121. Female sockets 177 receive male terminals 129 of electrical connectors 121 to establish an electrical connection between signal cable 122 and electrical connectors 121.

With reference to FIGS. 2, 5, and 6, the reader can see that signal cable 122 is configured to couple to multiple transducer coils 120. In the present example, signal cable 122 couples to two transducer coils 120. In other examples, the signal cable is configured to couple to three or more transducer coils. In some examples, the signal cable is configured to couple to a single transducer coil.

To enable coupling to two transducer coils 120, FIGS. 2, 5, and 6 show that signal cable 122 includes a trunk 170, a first branch 171, and a second branch 172. Trunk 170 is electrically coupled to audio connector 123. First branch 171 is electrically coupled to trunk 170 and to one of electrical connectors 121. Second branch 172 is electrically coupled to trunk 170 and to the other electrical connector 121. Signal cable 122 may be referred to a Y-cable or a splitter cable. The number of trunks included in the signal cable may be selected to correspond with the number of transducer coils included in the transducer.

The signal cable may be any currently known or later developed type of cable suitable for communicating audio signals between an audio device and transducer coils. The length and gauge of the signal cable may differ from the length and gauge of signal cable 122 shown in the figures.

### Audio Connector

Audio connector 123 enables selectively coupling signal cable 122 to audio device 190A. When signal cable 122 is selectively coupled to audio device 190A with audio connector 123, audio signals from audio device 190A are communicated to signal cable 122 and ultimately to transducer coils 120.

As shown in FIGS. 3-6, audio connector 123 includes a male terminal 180. Male terminal 180 projects away from signal cable 122. Male terminal 180 is complementarily configured with audio port 192 of audio device 190A to enable male terminal 180 to insert into audio port 192 of audio device 190A. When male socket 180 inserts into audio port 192, audio connector 123, signal cable 122, electrical connectors 121, and transducer coils 120 are electrically connected to audio device 190A.

### Covers

Covers 124 serve to protect transducer coils 120, electrical connectors 121, and the connection between signal cable 122 and audio connector 123. However, the covers are optional features not present in all transducer examples. In some examples, covers are used to cover some, but fewer components than covers 124 are used to cover in the present example. For example, the covers may cover the transducer coils without covering other components.

In the present example, covers 124 are heat-shrink plastic. However, the covers may be any currently known or later developed type of cover suitable for covering and protecting electrical components.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A wearable therapy device, comprising:
a wearable pouch defining an interior space; and
an electromagnetic frequency transducer disposed in the interior space and electrically coupled to an audio device, the electromagnetic frequency transducer being configured to convert sound signals into inaudible and tactilely imperceptible vibrations.

2. The wearable therapy device of claim 1, wherein the interior space of the pouch is sized to accommodates the electromagnetic frequency transducer and an audio device.

3. The wearable therapy device of claim 1, wherein the wearable pouch includes:
a strap configured to selectively mount to a user's body; and
a pouch coupled to the strap and defining the interior space.

4. The wearable therapy device of claim 3, wherein:
the pouch defines a pouch opening providing access to the interior space; and
the wearable pouch includes a closure mechanism operatively connected to the pouch at the pouch opening and configured to selectively cover the pouch opening.

5. The wearable therapy device of claim 4, wherein the closure mechanism is a zipper.

6. The wearable therapy device of claim 3, wherein:
the strap includes:
a first longitudinal end; and
a second longitudinal end opposite the first longitudinal end;
the wearable pouch includes a clip coupled to the strap; and
the clip includes:
a male end coupled to a first longitudinal end of the strap; and
a female end coupled to the second longitudinal end of the strap and configured to receive the male end.

7. The wearable therapy device of claim 1, wherein the electromagnetic frequency transducer includes a transducer coil in a coil configuration.

8. The wearable therapy device of claim 7, wherein the transducer coil defines a cylinder.

9. The wearable therapy device of claim 8, wherein the transducer coil includes an annular wall defining a hollow core disposed inside the annular wall.

10. The wearable therapy device of claim 9, wherein the transducer coil includes a terminal end extending from the annular wall away from the hollow core.

11. The wearable therapy device of claim 10, wherein the electromagnetic frequency transducer includes an electrical connector electrically coupled to the terminal end of the transducer coil.

12. The wearable therapy device of claim 11, wherein the terminal end of the transducer coil electrically connects to a positive terminal of the electrical connector.

13. The wearable therapy device of claim 11, wherein the electrical connector is a screw terminal connector.

14. The wearable therapy device of claim 11, wherein the electrical connector is a solder-seal connector.

15. The wearable therapy device of claim 11, wherein the electromagnetic frequency transducer includes a signal cable electrically coupled to the electrical connector and configured to conduct audio signals from an audio device when operatively coupled to an audio device.

16. The wearable therapy device of claim 16, wherein:
the electrical connector includes a male terminal; and
the signal cable includes a female socket complementarily configured with the male terminal of the electrical connector.

17. The wearable therapy device of claim 17, wherein the female socket is a tip, ring, screw connector.

18. The wearable therapy device of claim 16, wherein:
the transducer coil defines a first transducer coil;
the electrical connector defines a first electrical connector;
the electromagnetic frequency transducer includes a second transducer coil configured the same as the first transducer coil;
the electromagnetic frequency transducer includes a second electrical connector configured the same as the first electrical connector;
the second transducer coil is electrically connected to the second electrical connector;
the signal cable includes:
a trunk electrically coupled to the audio connector;
a first branch electrically coupled to the trunk and to the first electrical connector; and
a second branch electrically coupled to the trunk and to the second electrical connector.

19. The wearable therapy device of claim 15, wherein the electromagnetic frequency transducer includes an audio connector electrically connected to the signal cable and configured to selectively and electrically couple to an audio device.
